(19) United States
(12) Patent Application Publication
(10) Pub. No.: US 2026/0006460 A1
(43) Pub. Date: Jan. 1, 2026

(54) TASK SCHEDULING METHOD AND DEVICE FOR ARTIFICIAL INTELLIGENCE (AI) NETWORK FUNCTION SERVICE

(71) Applicant: BEIJING XIAOMI MOBILE SOFTWARE CO., LTD., Beijing (CN)

(72) Inventors: Dong CHEN, Beijing (CN); Yuze SUN, Beijing (CN)

(73) Assignee: BEIJING XIAOMI MOBILE SOFTWARE CO., LTD., Beijing (CN)

(21) Appl. No.: 18/881,536

(22) PCT Filed: Jul. 11, 2022
(86) PCT No.: PCT/CN2022/104993

§ 371 Date: Jan. 6, 2025

(51) Int. Cl. H04W 24/02; G06N 3/092; G06N 3/098

(52) U.S. Cl. CPC H04W 24/02; G06N 3/092; G06N 3/098

(57) ABSTRACT

A method for scheduling a task of an artificial intelligence (AI) network function service, performed by a first network node, includes: selecting at least two second network nodes from a plurality of second network nodes in response to a setup request for the AI network function service, wherein a node level of the plurality of second network nodes is less than a node level of the first network node; and sending a target task corresponding to the setup request for the AI network function service to the at least two second network nodes.

### CROSS-REFERENCE TO RELATED APPLICATIONS

The present application is a U.S. national phase of International Application No. PCT/CN2022/104993, filed on Jul. 11, 2022, the entire disclosure of which is incorporated herein by reference for all purposes.

### FIELD

The present disclosure relates to the field of mobile communication technologies, and in particular relates to a method and an apparatus for scheduling a task of an artificial intelligence (AI) network function service.

### BACKGROUND

Artificial intelligence (AI) will become one of the core technologies of future communication. The typical application scenarios of 6G and AI overlap by more than 80%, which are deeply integrated. Moreover, the large-scale coverage of 6G network will provide ubiquitous carrier space for the AI, solving the huge pain point of AI technology lacking carriers and channels, and greatly promoting the development and prosperity of AI industry. At present, many automatic means have been used to improve the efficiency of operation and maintenance in the various stages of planning, construction, maintenance and optimization of the network, but the overall level of autonomy of the network is not high and there is a great space for improvement. At present, a software defined network (SDN) and a network function virtualization (NFV) play a vital role in the evolution of network architecture, and the architecture of the SDN and the NFV makes the network more flexible but also more complex. Therefore, there are more factors to be considered in aspects such as scheduling and allocating network resource(s), a transmission path, and an optimization algorithm design, and more intelligent means are needed. The AI technology may help the network achieve a higher level of autonomy, thereby reducing costs and increasing efficiency.

However, the existing task scheduling for an AI network function service often lacks a common AI workflow and a unified technical framework, resulting in insufficient granularity for division of an AI network function and a fragmented application scenario. This in turn fails to meet users' personalized AI network service needs and fails to reasonably schedule a task of the AI network function service.

### SUMMARY

According to a first aspect of embodiments of the present disclosure, there is provided a method for scheduling a task of an artificial intelligence (AI) network function service, applied to a first network node, including: selecting at least two second network nodes from a plurality of second network nodes in response to a setup request for the AI network function service, in which a node level of the plurality of second network nodes is less than a node level of the first network node; and sending a target task corresponding to the setup request for the AI network function service to the at least two second network nodes.

According to a second aspect of embodiments of the present disclosure, there is provided a method for scheduling a task of an artificial intelligence (AI) network function service, applied to a second network node, including: receiving a subtask regarding a target task sent by a first network node, in which the subtask is obtained by dividing the target task by the first network node according to a task allocation weight in an optimal selection decision; performing the subtask according to a task model completed by local training; and sending a task execution result to the first network node.

According to a third aspect of embodiments of the present disclosure, there is provided a method for scheduling a task of an artificial intelligence (AI) network function service, applied to a user equipment (UE), including: sending a setup request for the AI network function service to an access and mobility management function (AMF); and receiving an aggregated task execution result transparently transmitted by the AMF.

According to a fourth aspect of embodiments of the present disclosure, there is provided a method for scheduling a task of an artificial intelligence (AI) network function service, applied to an access and mobility management function (AMF), including: receiving a setup request for the AI network function service sent by a user equipment (UE); and sending the setup request for the AI network function service to a first network node.

According to a fifth aspect of embodiments of the present disclosure, there is provided a communication device, including: a transceiver; a memory; and a processor, respectively connected to the transceiver and the memory, configured to control receiving and sending a wireless signal of the transceiver by executing computer-executable instructions on the memory, and perform the method of the first aspect or the second aspect or the third aspect or the fourth aspect.

According to a sixth aspect of embodiments of the present disclosure, there is provided a non-transitory computer storage medium having stored therein computer-executable instructions that, when executed by a processor, cause the method of the first aspect or the second aspect or the third aspect or the fourth aspect to be implemented.

According to an eleventh aspect of embodiments of the present disclosure, there is provided a communication system, including at least one of following network elements: an apparatus for scheduling the task of the AI network function service, applied to a first network node, and an apparatus for scheduling the task of the AI network function service, applied to a second network node.

### BRIEF DESCRIPTION OF THE DRAWINGS

The above and/or additional aspects and advantages of the present disclosure will become apparent and more readily appreciated from the following descriptions of embodiments made with reference to the drawings, in which:

FIG. 1 is a flow chart illustrating a method for scheduling a task of an artificial intelligence (AI) network function service according to embodiments of the present disclosure;

FIG. 2 is a flow chart illustrating a method for scheduling a task of an artificial intelligence (AI) network function service according to embodiments of the present disclosure;

FIG. 3 is a flow chart illustrating a method for scheduling a task of an artificial intelligence (AI) network function service according to embodiments of the present disclosure;

FIG. 4 is a flow chart illustrating a method for scheduling a task of an artificial intelligence (AI) network function service according to embodiments of the present disclosure;

FIG. 5 is a flow chart illustrating a method for scheduling a task of an artificial intelligence (AI) network function service according to embodiments of the present disclosure;

FIG. 6 is a flow chart illustrating a method for scheduling a task of an artificial intelligence (AI) network function service according to embodiments of the present disclosure;

FIG. 7 is a flow chart illustrating a method for scheduling a task of an artificial intelligence (AI) network function service according to embodiments of the present disclosure;

FIG. 8 is a sequence chart illustrating a method for scheduling a task of an artificial intelligence (AI) network function service according to embodiments of the present disclosure;

FIG. 9 is a block diagram illustrating an apparatus for scheduling a task of an artificial intelligence (AI) network function service according to embodiments of the present disclosure;

FIG. 10 is a block diagram illustrating an apparatus for scheduling a task of an artificial intelligence (AI) network function service according to embodiments of the present disclosure;

FIG. 11 is a block diagram illustrating an apparatus for scheduling a task of an artificial intelligence (AI) network function service according to embodiments of the present disclosure;

FIG. 12 is a block diagram illustrating an apparatus for scheduling a task of an artificial intelligence (AI) network function service according to embodiments of the present disclosure;

FIG. 13 is a structural diagram illustrating a communication device according to embodiments of the present disclosure;

FIG. 14 is a structural diagram illustrating a chip according to embodiments of the present disclosure.

### DETAILED DESCRIPTION

Reference will be made in detail to embodiments of the present disclosure, examples of which are shown in the drawings. The same or similar elements or the elements having the same or similar functions are denoted by the same or similar reference numerals throughout the descriptions. The embodiments described herein with reference to drawings are illustrative, and used to explain the present disclosure. The embodiments shall not be construed to limit the present disclosure.

At present, many automatic means have been used to improve the efficiency of operation and maintenance in the various stages of planning, construction, maintenance and optimization of the network, but an overall level of autonomy of the network is not high and there is a great space for improvement. At present, an architecture of a software defined network (SDN) and a network function virtualization (NFV) makes the network more flexible but also more complex. Therefore, there are more factors to be considered in aspects such as allocation of network resource(s), a transmission path, and an optimization algorithm design, and more intelligent means are needed. The AI technology may help the network achieve a higher level of autonomy, thereby reducing costs and increasing efficiency. Since the application of the AI technology in the communication network is relatively late, the existing network intelligent application is optimized and reformed on a traditional network architecture, which belongs to a plug-in application in general. The lack of the universal AI workflow and unified technical framework has resulted in fragmented network AI application scenarios and chimney-like research and development. The network AI function is simply superimposed on the existing network processes, and collaboration of cross-domain and cross-layer intelligent applications is difficult. Network data analysis function (NWDAF) may collect the data, perform the analysis, and provide the analysis result to other network functions. However, types of data analysis are not classified, and classification for a specific AI algorithm is not performed.

Therefore, the present disclosure proposes a method and apparatus for scheduling a task of an artificial intelligence (AI) network function service, which may divide/classify the AI network function according to specific algorithms and task types, thereby maximizing efficiency for scheduling the task and enabling the AI service to be performed efficiently and flexibly.

The method and switching apparatus provided by the present disclosure will be introduced in detail below with reference to the accompanying drawings.

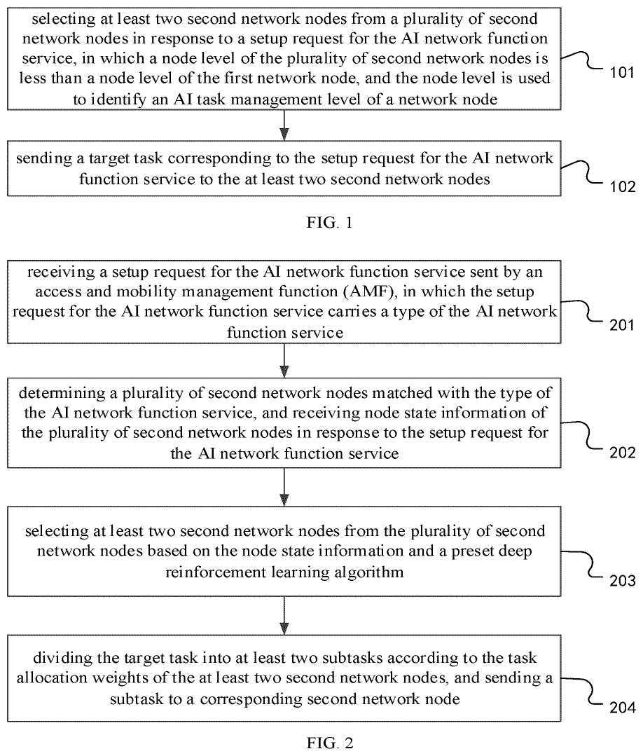

FIG. 1 is a flow chart illustrating a method for scheduling a task of an artificial intelligence (AI) network function service according to embodiments of the present disclosure. As shown in FIG. 1, the method is applied to a first network node and may include the following steps.

In step 101, at least two second network nodes are selected from a plurality of second network nodes in response to a setup request for the AI network function service, in which a node level of the plurality of second network nodes is less than a node level of the first network node, and the node level is used to identify an AI task management level of a network node.

In the embodiments of the present disclosure, it is possible to consider refining the AI network function and introducing a relationship between upper and lower levels. The first network node is an AI management level function at a higher level in a core network and may act as an AI task administrator to perform task scheduling and communication calculation resource allocation, which may be represented by AI0 in following embodiments. One first network node may correspond to a plurality of second network nodes at a next level, which are sub-AI network functions at a lower level in the core network, and may act as AI service implementers, which may be represented by AI1/AI2/ . . . /AIN in embodiments described below.

In response to the setup request for the AI network function service, the plurality of second network nodes matched with a type of the AI network function service may be selected from subordinate second network nodes by the first network node according to the type of the AI network function service carried in the setup request for the AI network function service, and at least two second network nodes for jointly participating in task calculation and communication in a present round of task execution may be further selected from the plurality of second network nodes to maximize an overall reward function.

In step 102, a target task corresponding to the setup request for the AI network function service is sent to the at least two second network nodes.

In the embodiments of the present disclosure, after selecting the at least two second network nodes based on step 101 in the embodiments, in a case where the first network node performs the task allocation, the target task corresponding to the setup request for the AI network function service may be transmitted and scheduled, and the at least two second network nodes jointly complete the whole target task, in which each second network node performs a part of sub-AI network functions of the target task. The target task may correspond to a fine-grained AI algorithm function service, including at least one of the following AI algorithm function services: classification, regression or clustering. Also, personalized AI services, such as image processing, speech recognition, machine translation, or business recommendation may be performed according to user's scene requirements. In all embodiments of the present disclosure, the second network node that is subordinate to the first network node refers to a second network node with a node level lower than that of the first network node.

Consequently, with the method for scheduling the task of the AI network function service provided by embodiments of the present disclosure, it is possible to consider refining the AI network function, introducing a relationship between upper and lower levels, and using the first network node at the high level to be responsible for signaling analysis of the AI network function service to implement resource allocation and distribution scheduling for the second network nodes at the low level. Specifically, the first network node selects, from the plurality of second network nodes, the at least two second network nodes for providing the corresponding AI network function service in response to the setup request for the AI network function service, and sends the target task corresponding to the setup request for the AI network function service to the at least two second network nodes. Based on the division/classification of AI network function and the hierarchical deployment of the network nodes, the efficiency for scheduling the task may be maximized, and the AI service may be performed efficiently and flexibly.

FIG. 2 is a flow chart illustrating a method for scheduling a task of an artificial intelligence (AI) network function service according to embodiments of the present disclosure. The method is applied to the first network node. Based on the embodiments shown in FIG. 1, as shown in FIG. 2, the method includes the following steps.

In step 201, the setup request for the AI network function service sent by an access and mobility management function (AMF) is received, in which the setup request for the AI network function service carries a type of the AI network function service.

In the embodiments of the present disclosure, any user equipment (UE) that has completed an initial registration procedure and is connected to a core network may send the setup request for the AI network function service to the AMF via a radio access network (RAN). Further, the AMF may send the setup request for the AI network function service to the first network node, i.e. an administrator of an AI service, to request the provision of the AI network function service for the user equipment. Furthermore, the first network node may receive the setup request for the AI network function service sent by the AMF. The setup request for the AI network function service may include at least one of the following parameters: the type of the AI network function service, an AI network function service identifier, or user equipment (UE) information. Those skilled in the art may understand that the setup request for the AI network function service may include other parameters, or a combination of the foregoing and other parameters, which is not limited by the embodiments of the present disclosure.

In step 202, in response to the setup request for the AI network function service, a plurality of second network nodes matched with the type of the AI network function service are determined, and node state information of the plurality of second network nodes are received.

The node state information includes at least one of the following parameters: a central processing unit (CPU) calculation frequency, energy consumption information, wireless bandwidth information and channel state information.

In the embodiments of the present disclosure, the first network node may also receive a preset task type for the AI network function service uploaded by all its subordinate second network nodes before receiving the setup request for the AI network function service. Since the second network nodes subordinate to the first network node may correspond to multiple task types, in a case where the plurality of second network nodes matched with the type of the AI network function service are determined in response to the setup request for the AI network function service, in order to save a calculation resource, the plurality of second network nodes corresponding to the preset task type which is the same as the type of the AI network function service may be firstly selected from all the second network nodes, and the node state information of the selected second network nodes is further received, thereby performing more refined selection among the plurality of second network nodes corresponding to the same type of the AI network function service on the basis of the node state information.

In step 203, at least two second network nodes are selected from the plurality of second network nodes based on the node state information and a preset deep reinforcement learning algorithm.

The preset deep reinforcement learning algorithm may be a double deep Q-network (DDQN) algorithm. By designing a reward mechanism, the first network node may find a strategy combination of the second network nodes corresponding to a maximum reward value, thereby reasonably scheduling the task and allocating the resource(s), and providing the user with the flexible and efficient AI service. It should be noted that other realizable deep reinforcement learning algorithms may also be selected as the preset deep reinforcement learning algorithm. In the present embodiment, the technical solution in the present disclosure is described by taking the DDQN algorithm as an example, but this does not constitute a specific limitation of the technical solution in the present disclosure.

Regarding task scheduling of the AI network function service, three steps are mainly considered: i) the first network node sends input data; ii) the second network node performs local training calculation; iii) the first network node receives an output result. In this process, the two main objectives are: i) minimizing energy consumption; ii) letting as many second network nodes as possible participate in training. In the embodiments of the present disclosure, task scheduling requirements between the AI network function services are modeled as optimization objectives and constraints, which in turn seek an optimal solution to the problem. Optimization indexes mainly include at least one of the following parameters: time delay, energy consumption, revenue and expense, and physical equipment. The present disclosure introduces a modeling method for the optimization objectives and constraints from two major aspects of performance and energy consumption. The performance may include service delay, which is a time taken between an application submitting a request and receiving a response, and a service deadline. The service delay is an important indicator of resource scheduling optimization. In the present disclosure, the service delay is divided into two categories: time-consuming on computing nodes and time-consuming for transmission between nodes, namely, computing delay and communication delay. Through the reasonable optimization strategy and task scheduling method, the service delay may be effectively reduced and the system performance may be improved. In addition to minimizing the time delay, a deadline of the task may represent the urgency of the task. Task completion deadlines may be classified into a hard deadline and a soft deadline. Different tasks have different time delay sensitivities. In a case where some tasks are not completed before the deadline, serious consequences will occur, thus they are defined as hard deadline constraints; otherwise, they are defined as soft deadline constraints. However, the energy consumption is one of the main costs of a data center, including computer equipment, refrigeration and heat dissipation equipment and the like. It is very important to schedule the target task corresponding to the setup request for the AI network function service to the second network nodes and to ensure the normal operation of a physical equipment entity bearing the second network node. The energy consumption mainly refers to battery power consumption of a server and a mobile terminal device, which is divided into four parts: monitoring, calculation, communication and execution. The monitoring of the power consumption is related to a size and duration of a data packet; the calculation of the energy consumption depends on the hardware parameters of a specific entity; the communication of the power consumption is divided into two parts: uploading and receiving; the execution of the energy consumption is positively correlated with specific execution tasks and times. It may be key point to consider how to effectively save the energy consumption and maintain the stability of the system.

Regarding time constraint, total time delay mainly includes a local model training time and a parameter result uploading time of the second network node. Since a downlink communication rate is far greater than an uplink communication rate, a time for the first network node to transmit an instruction to the second network node may be ignored. Each second network node performs its own task in parallel each time a task is transmitted.

$${t}_{i}^{c o m p} and {t}_{i}^{u p}$$

are respectively used to represent the local model training time and the result uploading time in a case where the second network node executes the task.

$${t}_{i}^{c o m p}$$

depends on: i) a computation time; ii) a waiting time in a task queue of the second network node. The waiting time reflects a queuing time of remaining workload that is ongoing at the second network node. The

$${t}_{i}^{c o m p}$$

may be expressed as

$${t}_{i}^{c o m p} = {D}_{i} + {T}_{i} ,$$

where Dᵢ represents the computation time of the current task, and Tᵢ represents a waiting delay. yᵢ∈{0,1} may be a binary variable indicating whether an i^{th} second network node will execute the task in a current round, 1 representing execution, and 0 representing no execution, i.e. not participating in scheduling of this task. There are the following conditions: yᵢ∈{0,1}, ∀i∈{1, . . . , N}. Since each second network node works in parallel, the total calculation time and transmission time for each second network node to complete the task should satisfy the following upper limit:

$${L}_{max} \geq max \{ {t}_{i}^{c o m p} + {t}_{i}^{u p} \} ,$$

∀i∈{1, . . . , N}. A heterogeneous computing capability of the second network node is reflected in different values of

$${t}_{i}^{c o m p} .$$

Moreover, because each second network node carries different amounts of training task data and different communication channel qualities, the time

$${t}_{i}^{u p}$$

required for uploading the results is also different.

Regarding the energy consumption, the energy consumption of each edge device includes two aspects: on the one hand, energy consumption of uploading the model (result) from the second network node to the first network node, and on the other hand, energy consumption of the local model training of the second network node. The energy consumption of the local training of the second network node depends on time and space complexity of the particular AI algorithm and a size of a model parameter. Since tasks scheduled and transmitted by the first network node are different each time, and a set of second network nodes participating in execution of each task is also different, and an amount of subtask data carried on each second network node is also significantly different, there is also a difference in the energy consumption of the local training calculation, which is expressed here as:

$${E}_{i}^{c o m p} ,$$

this item relates to a physical entity parameter such as a clock frequency, a running power and the like. Total local training energy consumption of each second network node is:

$${E}^{comp} = {\sum }_{i ∈ N} {E}_{i}^{c o m p} {y}_{i} .$$

In a case where minimum transmission time for sending 1 bit of information between the second network node and the first network node is Ti, energy consumption related to uploading data is: Eᵢ^{up}=pᵢNᵢTᵢ, where pᵢ is information transmission power, and Nᵢ is an amount of information of result data uploaded to the first network node by the second network node. Therefore, the total energy consumption in the upload process is:

$${E}^{u p} = {\sum }_{i ∈ N} {E}_{i}^{u p} \cdot {y}_{i} .$$

Furthermore, a total energy consumption loss of all second network nodes performing the task in a round of iterations is: E=E^{comp}+E^{up}.

In embodiments of the present disclosure, a primary goal is to enable more second network nodes to participate in training while satisfying constraints, and to minimize the system delay and energy consumption, thereby completing the AI network function service faster and more efficiently. The deep reinforcement learning algorithm, e.g., the DDQN algorithm, is configured to help the first network node interact with a system environment, and select a strategy and a method that may obtain the maximum reward value. The steps in embodiments may specifically include: for a purpose of minimizing the system delay and the energy consumption and maximizing a number of second network nodes participating in a service, defining a state space as the node state information of the second network node, defining an action space as a combination of the second network nodes selected for the setup request for the AI network function service, and establishing a deep reinforcement learning model based on the DDQN algorithm; and determining, according to the node state information, a reward function of each action in an action set by using the deep reinforcement learning model, and determining an optimal selection decision for the second network node corresponding to the AI network function service according to the reward function, in which the action is used for characterizing a selection decision for the second network node corresponding to the AI network function service, and the optimal selection decision includes at least two second network nodes and task allocation weights of the at least two second network nodes.

Accordingly, an overall algorithm idea of federated learning may be used in a case of determining, according to the node state information, the reward function of each action in the action set by using the deep reinforcement learning model. The first network node uses a weighted average algorithm to aggregate and update local model parameter(s) trained by the second network node participating in each iteration, and then sends a global model to each second network node, and the second network node continues to use the updated model for training, which is iterated for a number of rounds until the requirements of the first network node are reached. Since there is a difference for each task, there are the plurality of second network nodes, and each second network node adapts to a different task type. Each round therefore needs to find suitable second network node(s) to participate in the training in order to maximize resource efficiency and resulting AI service quality. The steps in embodiments may specifically include: determining, according to the node state information, the action set by using the deep reinforcement learning model, and repeatedly performing a determination process of the reward function until a current action is determined to be a last action in the action set; in which the determination process of the reward function includes: taking a next action as the current action according to an action selection order in the action set; receiving a local model parameter uploaded by the second network node included in the current action, and weighted aggregating the local model parameter according to a size of local data to obtain a global model parameter based on a federated average (FedAvg) algorithm; transmitting the global model parameter to the second network node included in the current action to continue to train a task model of the second network node based on the global model parameter, and obtaining a reward function of the current action after training is completed.

In a case of determining an optimal selection decision for the target task regarding the second network node based on the reward function, the step in embodiments may specifically include: determining, in the action set, a target action corresponding to a maximum reward function, and determining a selection policy characterized by the target action as an optimal selection decision for the target task regarding the second network node.

Specifically, in a case of selecting the at least two second network nodes from the plurality of second network nodes based on the node state information and the preset deep reinforcement learning algorithm, the following iterative process may be repeatedly executed until an overall task target of the first network node is reached. The optimal selection decision for the second network node corresponding to the target task is output by using the trained deep reinforcement learning model.

Step 1, for the purpose of minimizing the system delay and the energy consumption and maximizing the number of second network nodes participating in the service, the state space is defined as the node state information of the second network node, the action space is defined as the selection decision of the second network node corresponding to the target task, and the deep reinforcement learning model based on the DDQN algorithm is established, in which the model parameters include: maximum number of iterations T, the action set, a decay factor γ, an exploration rate ∈, a Q function, a number of samples m used to represent a batch gradient descent for a Markov decision process, a state S, an action A, a reward function R after the execution of the action A, and a next state S′ after the execution of the action A.

In step 1, the state space is determined by resource state information of the N second network nodes, and system states of all the devices include a remaining electric quantity of a battery, a channel bandwidth, a channel gain, and a power. The state S is represented as:

$$S = {\prod }_{i = 1}^{N} {S}_{i}$$

where Sᵢ represents a state of the second network node, which may be represented as: Sᵢ={fᵢ, eᵢ, rᵢ, cᵢ, tᵢ} In the formula, fᵢ represents a CPU calculation frequency of the second network node, eᵢ represents an energy consumption situation of the second network node, rᵢ represents a wireless bandwidth situation, cᵢ represents channel state information, and tᵢ represents a preset task type that may be executed.

The action space is a selection strategy combination of the first network node, which indicates second network nodes selected to participate in the training task of the current round. The action A may be represented as:

$$A = {\prod }_{i = 1}^{N} {A}_{i}$$

where Aᵢ={0}∪{1} represents an action state of the second network node. Ai=0 represents that the second network node Ali does not participate in this round of update global model, and Ai=1 represents that the second network node Ali participates in this round of model update to train a local model thereof.

The reward function R refers to an instantaneous reward obtained by the system in performing the action A in the state S. The reward function should be proportional to a number of second network nodes participating in each round of task, and inversely proportional to energy consumption and training delay. The reward function is defined as follows:

$$R ( s , a ) = {α}_{1} \frac{m}{n} - {α}_{2} \frac{E}{{E}_{max}} - {α}_{3} \frac{T}{{T}_{max}}$$

where m represents a number of second network nodes participating in this round, Emax represents a total energy of the system, and T represents the maximum delay of the number of the second network nodes participating in this round of iteration,

$$T = max \{ {t}_{i}^{c o m p} + {t}_{i}^{u p} \} , ∀ i ∈ N .$$

The discount factor γ is a discount factor between 0 and 1. The further a reward is from a current time step, the less important it becomes. γ=0 indicates that the strategy is short-sighted and only considers a current immediate reward Rt. Balancing a current time award with a future award may set γ to a larger value, for example, γ=0.9. In a case where the state and environment are model-based, future cumulative rewards may be obtained in advance without the need for discounting calculation. Here, γ is set as 0.99.

The Q function is a long-term reward, i.e., an action value function, and defines a reward expectation value R obtained after taking the action A in the state S and continuously executing a policy. The first network node updates the Q value based on an empirical playback mechanism:

$$Q ' ( s , a ) = ( 1 - β ) Q ( s , a ) + β [ R ( s , a ) + γ {max}_{{a}^{′} ∈ A} Q ( s ' , a ' ) ]$$

where β represents a learning rate and γ represents the discount factor. The first network node may make a judgement depending on the Q value after updating the Q value. According to any state S, the first network node may select the action A with a maximum accumulated reward R as the optimal selection decision for the target task regarding the second network node.

Step 2, an initialization state S is a first state of a current state sequence, and a feature vector φ(S) of the initialization state S is obtained.

Step 3, φ(S) is used as an input in a network structure Q to obtain Q value outputs corresponding to all actions of the network structure Q, and an ∈-Greedy method is configured to select a corresponding action A from current Q value outputs.

Step 4, the current action A is executed in the state S, and the reward function R and a feature vector φ(S′) corresponding to the next state S′ are obtained after the execution ends.

Step 5, a five-member {φ(S), A, R, φ(S′), end} is stored into an experience playback set M.

Step 6, it makes that S=S′.

Step 7, m samples, {φ(Sj), Aj, Rj, φ(S′j), endj}, j=1,2 . . . , m, are sampled from the experience playback set M, and a current target Q value is calculated.

Step 8, based on the current target Q value, a mean square error loss function is configured to update an action value function weight value θ of the Q network via gradient back propagation of the neural network.

An online neural network updates the weight value θ according to the experience playback set M, and a target neural network periodically resets the weight value θ′=θ by using a gradient descent algorithm. The mean square error loss function may be defined as:

$$L θ = {E [ y - Q ( s , a ; θ ) ]}^{2} .$$

The current target Q value y is defined as:

$$y = R ( s , a ) + γ Q ' ( s ' , arg max Q ( s ' , a ' ; θ ) ; θ ' ) .$$

Step 9, in a case where S′ is a termination state, the current round of iteration is completed, otherwise go to step 3.

Step 10, steps 2 to 9 are iteratively performed until an overall task goal of the first network node is reached. The optimal selection decision for the target task regarding the second network node is determined by using the reward function R for each action A in the action set.

The optimal selection decision includes at least two second network nodes, and the task allocation weights of the at least two second network nodes.

In step 204, the target task is divided into at least two subtasks according to the task allocation weights of the at least two second network nodes, and a subtask is sent to a corresponding second network node.

In the embodiments of the present disclosure, after determining the optimal selection decision for the second network node corresponding to the AI network function service, the target task is divided into at least two subtasks according to the task allocation weights of the at least two second network nodes in the optimal selection decision, and the subtask is sent to the corresponding second network node. For example, it is determined that the optimal selection decision for the second network node corresponding to the AI network function service includes the second network nodes a, b and c, and the task allocation weights corresponding to the second network nodes a, b and c are successively: 20%, 50% and 30%, and then the whole target task may be divided into a subtask 1, a subtask 2 and a subtask 3 according to the task allocation weights, in which the subtask 1 accounts for 20% of the whole target task, the subtask 2 accounts for 50% of the whole target task, and the subtask 3 accounts for 30% of the whole target task. Tasks of the subtask 1, the subtask 2 and the subtask 3 do not coincide, and correspond to some tasks in the target tasks. Therefore, the subtask 1 may be sent to the second network node a, the subtask 2 may be sent to the second network node b, and the subtask 3 may be sent to the second network node c, such that the target tasks are jointly completed by using the second network nodes a, b and c.

Consequently, with the method for scheduling the task of the AI network function service provided by the embodiments of the present disclosure, it is possible to consider refining the AI network function, introducing a relationship between upper and lower levels. By introducing the deep reinforcement learning algorithm and the reward mechanism based on the deep reinforcement learning algorithm in the process for scheduling the task of the network function service, the first network node at the high level may find a policy combination of the second network nodes at the low level corresponding to the maximum reward value, thereby reasonably allocating task resources, achieving the maximization of task scheduling efficiency, such that the AI service may be performed efficiently and flexibly.

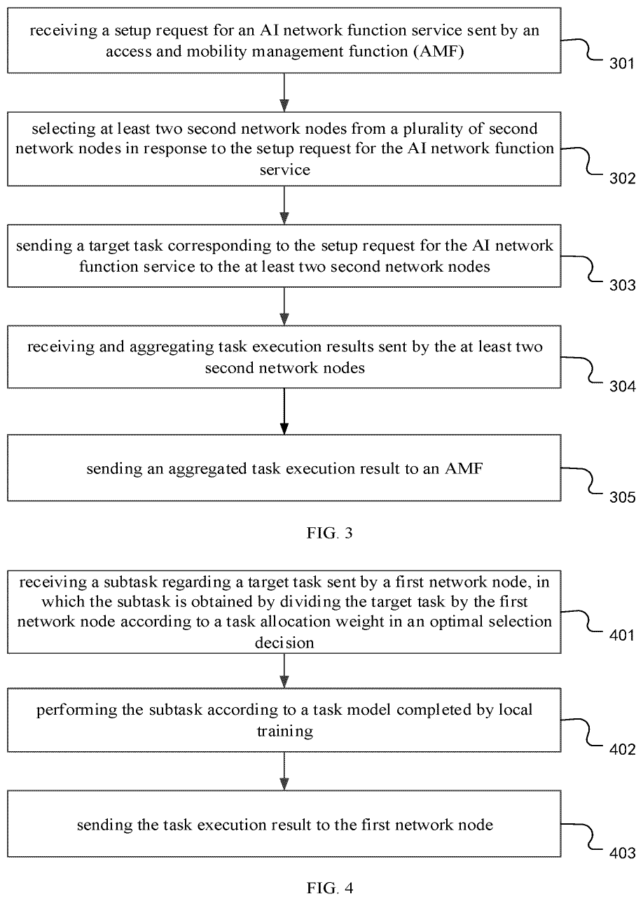

FIG. 3 is a flow chart illustrating a method for scheduling a task of an artificial intelligence (AI) network function service according to embodiments of the present disclosure. The method is applied to the first network node. Based on embodiments shown in FIGS. 1 and 2, as shown in FIG. 3, the method may include the following steps.

In step 301, a setup request for an AI network function service sent by an access and mobility management function (AMF) is received.

In embodiments of the present disclosure, the implementation process of step 301 is the same as that of the embodiments of step 201, and will not be repeated here.

In step 302, at least two second network nodes are selected from a plurality of second network nodes in response to the setup request for the AI network function service.

In embodiments of the present disclosure, the implementation process of step 302 may refer to the embodiments of steps 202 to 203, which will not be repeated here.

In step 303, a target task corresponding to the setup request for the AI network function service is sent to the at least two second network nodes.

In embodiments of the present disclosure, the implementation process of step 303 is the same as that of the embodiments of step 204, and will not be repeated here.

In step 304, task execution results sent by the at least two second network nodes are received and aggregated.

In the embodiments of the present disclosure, since the at least two second network nodes jointly complete the target task, each second network node is responsible for some of the subtasks. Therefore, after the first network node receives the task execution results sent by the at least two second network nodes, the task execution results sent by the at least two second network nodes may be aggregated to obtain a complete task execution result of the target task. The process of aggregation may structure the task execution results to meet the integrity requirements.

In step 305, an aggregated task execution result is sent to an AMF.

In the embodiments of the present disclosure, the complete task execution result of the aggregated target task may be sent to the AMF to utilize the AMF to transparently transmit the task execution result to the UE which sends the setup request for the AI network function service. Furthermore, after receiving the aggregated task execution result, the UE may further provide a feedback according to the task execution result, send the feedback to the AMF, and utilize the AMF to send the feedback to the first network node. Accordingly, the first network node may further receive the feedback on the aggregated task execution result, and may further adjust and optimize the task scheduling strategy according to the feedback, such that task scheduling may better meet the personalized needs of the user.

Consequently, with the method for scheduling the task of the AI network function service provided by embodiments of the present disclosure, in response to the setup request for the AI network function service, the first network node may select the at least two second network nodes for providing a corresponding AI network function service from the plurality of second network nodes, send the target task corresponding to the setup request for the AI network function service to the at least two second network nodes, and utilize the at least two second network nodes to jointly execute the target task, thereby reasonably allocating task resources, achieving the maximization of task scheduling efficiency, such that the AI service may be performed efficiently and flexibly.

FIG. 4 is a flow chart illustrating a method for scheduling a task of an artificial intelligence (AI) network function service according to embodiments of the present disclosure. The method is applied to a second network node, and may include the following steps.

In step 401, a subtask regarding a target task sent by a first network node is received, in which the subtask is obtained by dividing the target task by the first network node according to a task allocation weight in an optimal selection decision.

In the embodiments of the present disclosure, before performing steps of the present embodiment, the second network node may further upload node state information and a preset task type of the AI network function service to the first network node in real time, thereby facilitate task allocation and scheduling performed by the first network node corresponding to the current second network node(s). The node state information includes at least one of the following parameters: a central processing unit (CPU) calculation frequency, energy consumption information, wireless bandwidth information and channel state information. Further, in response to the first network node selecting the current second network node for performing the target task with the other selected second network nodes, the current second network node may receive the subtask regarding the target task sent by the first network node.

In step 402, the subtask is performed according to a task model completed by local training.

In the embodiments of the present disclosure, before executing the steps of this embodiment, it further needs to pre-train a local task model. Specifically, in a process of the first network node determining the optimal selection decision based on a deep reinforcement learning model, in a case where a selected action includes the current second network node, the second network node sends a local model parameter to the first network node, and further receives a global model parameter transmitted by the first network node, in which the global model parameter is obtained by the first network node based on a federated average (FedAvg) algorithm, the first network node weighted aggregates the local model parameter according to a size of local data after receiving the local model parameter uploaded by the second network node included in a current action. Finally, the task model completed by the local training is obtained by iteratively training the task model based on the global model parameter and using a sample set matched with the target task.

In a specific application scenario, in a case where the UE registers and sends the setup request for the AI network function service, the UE further stores a structured data set of a target task corresponding to the setup request for the AI network function service to a user data register (UDR), and stores an unstructured data set of a target task corresponding to the setup request for the AI network function service to an unstructured data storage function (UDSF). Accordingly, for this embodiment, in a case of performing the subtask according to the task model completed by the local training, the steps of this embodiment may specifically include: retrieving structured data matched with the subtask in the UDR, and retrieving unstructured data matched with the subtask in the UDSF; and inputting the structured data and the unstructured data into the task model completed by the local training, and outputting a task execution result of the subtask by using the task model completed by the local training.

In step 403, the task execution result is sent to the first network node.

Consequently, with the method for scheduling the task of the AI network function service provided by the embodiments of the present disclosure, it is possible to consider refining the AI network function, introducing a relationship between upper and lower levels, and using the first network node at the high level to be responsible for signaling analysis of the AI network function service to implement resource allocation and distribution scheduling for the second network node(s) at the low level. The second network node may receive the subtask regarding the target task sent by the first network node, perform the subtask according to the task model completed by the local training, and jointly complete the target task with other second network nodes selected by the first network node. By dividing/classifying the AI network functions, the efficiency for scheduling the task may be maximized, and the AI service may be performed efficiently and flexibly.

FIG. 5 is a flow chart illustrating a method for scheduling a task of an artificial intelligence (AI) network function service according to embodiments of the present disclosure. The method is applied to a user equipment (UE), and may include the following steps.

In step 501, a setup request for the AI network function service is sent to an AMF.

In the embodiments of the present disclosure, the UE may first perform a registration process to connect to a core network. After completing the registration, the setup request for the AI network function service may be sent to the AMF via an RAN, such that the setup request for the AI network function service is sent to the first network node by using the AMF, i.e., an administrator of an AI service, to request to provide the AI network function service for the UE. Moreover, in a case where the UE registers and sends the setup request for the AI network function service, it will also store a structured data set of the target task corresponding to the setup request for the AI network function service in a UDR, and store an unstructured data set of the target task corresponding to the setup request for the AI network function service in a UDSF. Therefore, in a case where the first network node subsequently schedules at least two second network nodes to execute subtasks corresponding to the target task, each second network node may retrieve structured data matched with the subtask in the UDR, and retrieve unstructured data matched with the subtask in the UDSF.

In step 502, an aggregated task execution result transparently transmitted by the AMF is received.

In the embodiments of the present disclosure, in a case where the first network node schedules the at least two second network nodes to execute the subtasks corresponding to the target task and receives task execution results fed back by the at least two second network nodes, the task execution results sent by the at least two second network nodes may be aggregated to obtain a complete task execution result of the target task, the aggregated complete task execution result of the target task may be sent to the AMF, and the AMF may transparently transmit the complete task execution result to the UE via the RAN. Furthermore, the UE that sends the setup request for the AI network function service may receive the task execution result transparently transmitted by the AMF.

As an optional method, after receiving the task execution result transparently transmitted by the AMF, the UE may send a reception response message of the task execution result to the AMF, and may also send feedback on the aggregated task execution result.

Consequently, with the method for scheduling the task of the AI network function service provided by the embodiments of the present disclosure, the UE may use the AMF to implement data interaction with the first network node, such that the first network node may determine a specific AI task type according to the setup request for the AI network function service of the UE, and select a corresponding AI network function, thereby reasonably allocating task resources and providing a fine-grained AI network function service.

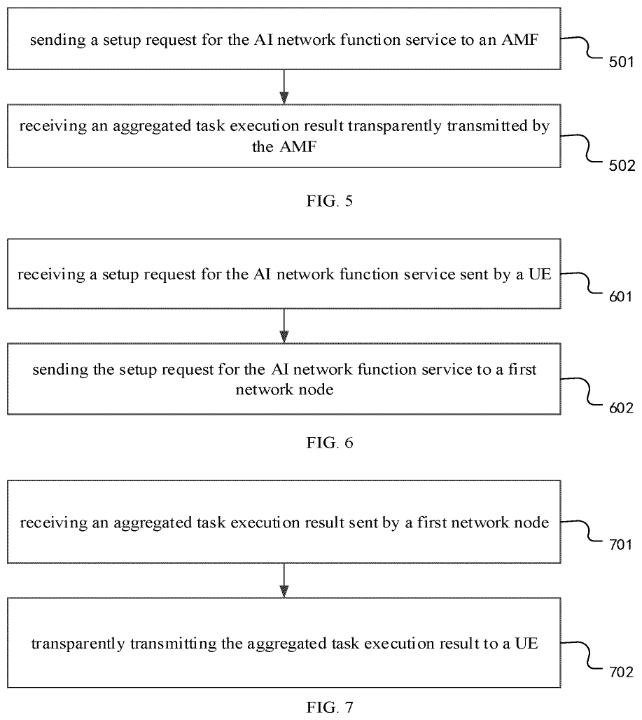

FIG. 6 is a flow chart illustrating a method for scheduling a task of an artificial intelligence (AI) network function service according to embodiments of the present disclosure. The method is applied to an AMF, and may include the following steps.

In step 601, a setup request for the AI network function service sent by a UE is received.

In step 602, the setup request for the AI network function service is sent to a first network node.

In embodiments of the present disclosure, after receiving the setup request for the AI network function service sent by the UE, the AMF may send the setup request for the AI network function service to the first network node, such that the first network node may perform information interaction with the UE. Specifically, in response to the setup request for the AI network function service, the first network node selects a plurality of second network nodes matched with the type of the AI network function service from subordinate second network nodes according to a type of the AI network function service carried in the setup request for the AI network function service, and further selects at least two second network nodes for participating in task calculation and communication in this round of task execution from the plurality of second network nodes. Furthermore, the first network node is configured to send a target task corresponding to the setup request for the AI network function service to the at least two second network nodes. The two second network nodes jointly complete the whole target task, and each second network node performs some of sub-AI network functions of the target task. The target task may correspond to a fine-grained AI algorithm function service, including at least one of the following AI algorithm function services: classification, regression, or clustering. Also, personalized AI services, such as image processing, speech recognition, machine translation, or business recommendation may be performed according to the user's scene requirements.

Consequently, with the method for scheduling the task of the AI network function service provided by the embodiments of the present disclosure, it is possible to consider refining the AI network function, introducing a relationship between upper and lower levels, and using the first network node at the high level to be responsible for signaling analysis of the AI network function service to implement the resource allocation and distribution scheduling for the second network nodes at the lower level. After receiving the setup request for the AI network function service sent by the UE, the AMF may send the setup request for the AI network function service to the first network node to further use the first network node to reasonably allocate task resources, thereby maximizing the task scheduling efficiency and enabling the AI service to be performed efficiently and flexibly.

FIG. 7 is a flow chart illustrating a method for scheduling a task of an artificial intelligence (AI) network function service according to embodiments of the present disclosure. The method is applied to an AMF. Based on embodiments shown in FIG. 6, as shown in FIG. 7, the method may include the following steps.

In step 701, an aggregated task execution result sent by the first network node is received.

In step 702, the aggregated task execution result is transparently transmitted to the UE.

In the embodiments of the present disclosure, after receiving a task execution result of at least two scheduled second network nodes for some subtasks of the target task, the first network node may aggregate the task execution results of the subtasks and send the aggregated task execution result to the AMF. Furthermore, after receiving the aggregated task execution result sent by the first network node, the AMF may transparently transmit the aggregated task execution result to the UE.

As an optional method, after transparently transmitting the aggregated task execution result to the UE, the AMF may further receive a receipt response message of the task execution result and feedback on the aggregated task execution result sent by the UE. Furthermore, the AMF may send the feedback on the aggregated task execution result to the first network node, such that the first network node may adjust and optimize the scheduling strategy according to the feedback.

Consequently, with the method for scheduling the task of the AI network function service provided by the embodiments of the present disclosure, after receiving the aggregated task execution result sent by the first network node, the AMF may transparently transmit the aggregated task execution result to the UE, and send the feedback on the aggregated task execution result sent by the UE to the first network node, thereby implementing data interaction of the task execution result between the UE and the first network node, and facilitating the first network node to adjust and optimize the scheduling strategy.

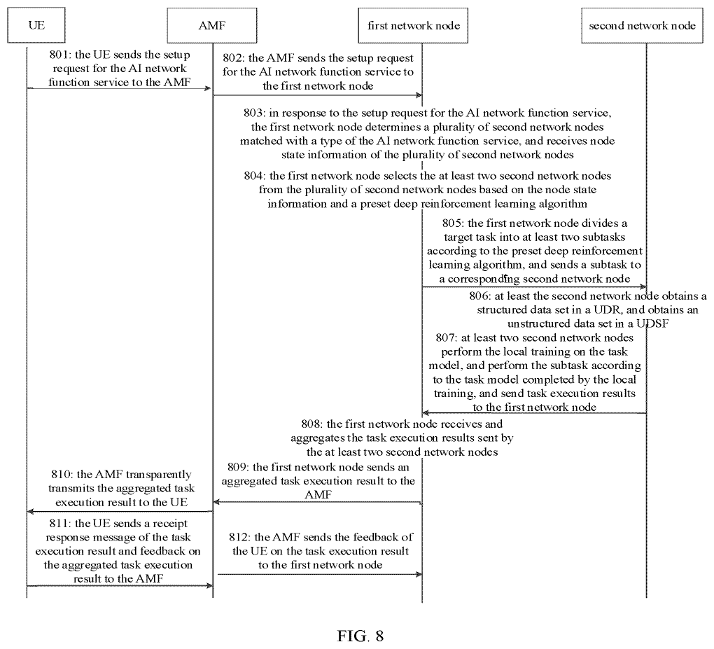

FIG. 8 is a sequence chart illustrating a method for scheduling a task of an artificial intelligence (AI) network function service according to embodiments of the present disclosure. The method is applied to a communication system, which includes: an apparatus for scheduling the AI network function service applied to a first network node, an apparatus for scheduling the AI network function service applied to a second network node, and an apparatus for scheduling the AI network function service applied to an AMF. In the communication system, the UE sends a setup request for the AI network function service to the AMF; the apparatus for scheduling the AI network function service applied to the AMF sends the setup request for the AI network function service to the first network node; the apparatus for scheduling the AI network function service applied to the first network node selects at least two second network nodes from a plurality of second network nodes in response to the setup request for the AI network function service, and sends a target task corresponding to the setup request for the AI network function service to the at least two second network nodes; the apparatus for scheduling the AI network function service applied to the at least two second network nodes receives a subtask regarding the target task sent by the first network node, and sends a task execution result to the first network node after performing the subtask according to a task model completed by local training.

Referring to FIG. 8, the communication system, when executed, may include the following steps.

In step 801, the UE sends the setup request for the AI network function service to the AMF.

The setup request for the AI network function service may include a type of the AI network function service, an identifier of the AI network function service, an UE information and the like.

In step 802, the AMF sends the setup request for the AI network function service to the first network node.

In step 803, in response to the setup request for the AI network function service, the first network node determines a plurality of second network nodes matched with a type of the AI network function service, and receives node state information of the plurality of second network nodes.

The node state information includes at least one of the following parameters: a CPU calculation frequency, energy consumption information, wireless bandwidth information and channel state information.

In step 804, the first network node selects the at least two second network nodes from the plurality of second network nodes based on the node state information and a preset deep reinforcement learning algorithm.

The preset deep reinforcement learning algorithm may be a DDQN algorithm. By designing a reward mechanism, the first network node may find a strategy combination of the second network nodes corresponding to a maximum reward value, thereby reasonably scheduling a task and allocating a resource, and providing users with flexible and efficient AI service.

In step 805, the first network node divides a target task into at least two subtasks according to the preset deep reinforcement learning algorithm, and sends a subtask to a corresponding second network node.

In step 806, at least the second network node obtains a structured data set in a UDR, and obtains an unstructured data set in a UDSF.

In a case where the UE registers and sends the setup request for the AI network function service, the UE further stores a structured data set of a target task corresponding to the setup request for the AI network function service into the UDR, and stores an unstructured data set of the target task corresponding to the setup request for the AI network function service into the UDSF. Therefore, in a case where the at least two second network nodes execute the subtasks according to a task model completed by local training, the at least the second network node retrieves structured data matched with the subtask in the UDR, and retrieves unstructured data matched with the subtask in the UDSF.

In step 807, at least two second network nodes perform the local training on the task model, perform the subtasks according to the task model completed by the local training, and send task execution results to the first network node.

In step 808, the first network node receives and aggregates the task execution results sent by the at least two second network nodes.

In step 809, the first network node sends an aggregated task execution result to the AMF.

In step 810, the AMF transparently transmits the aggregated task execution result to the UE.

In step 811, the UE sends a receipt response message of the task execution result and feedback on the aggregated task execution result to the AMF.

In step 812, the AMF sends the feedback of the UE on the task execution result to the first network node.

Consequently, with the method for scheduling the task of the AI network function service provided by the embodiments of the present disclosure, it is possible to consider refining the AI network function, introducing a relationship between upper and lower levels, and using the first network node at the high level to be responsible for signaling analysis of the AI network function service to implement resource allocation and distribution scheduling for the second network node at the low level. The first network node selects the at least two second network nodes for providing corresponding AI network function services from the plurality of second network nodes in response to the setup request for the AI network function service, such that resource allocation and distribution deployment of the AI network function services may be realized. By dividing/classifying AI network functions, the efficiency for scheduling the task may be maximized, and the AI service may be performed efficiently and flexibly.

In the above embodiments provided in the present disclosure, the method provided by embodiments of the present disclosure is introduced from the perspective of the first network node, the second network node, the UE and the AMF respectively. In order to implement the various functions in the method provided by above embodiments of the present disclosure, the first network node, the second network node, the UE and the AMF may include a hardware structure and a software module to implement the above functions in the form of a hardware structure, a software module, or a hardware structure plus a software module. Any of the above functions may be implemented in the form of a hardware structure, a software module, or a hardware structure plus a software module.

Corresponding to the method for scheduling the task of the AI network function service provided by the above embodiments, the present disclosure also provides an apparatus for scheduling a task of an AI network function service. Since the apparatus for scheduling the task of the AI network function service provided by embodiments of the present disclosure corresponds to the method for scheduling the task of the AI network function service provided by above embodiments, the implementation of the method for scheduling the task of the AI network function service is also applicable to the apparatus for scheduling the task of the AI network function service provided by this embodiment, which will not be described in detail in this embodiment.

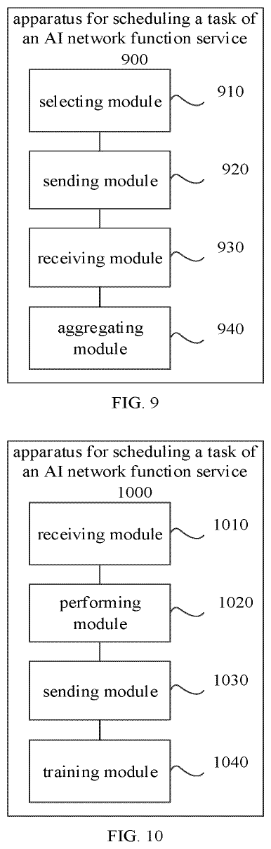

FIG. 9 is a block diagram illustrating an apparatus 900 for scheduling a task of an artificial intelligence (AI) network function service according to embodiments of the present disclosure. The apparatus 900 for scheduling the task of the AI network function service may be applied to a first network node.

As shown in FIG. 9, the apparatus 900 may include: a selecting module 910 configured to select at least two second network nodes from a plurality of second network nodes in response to a setup request for the AI network function service, in which a node level of the plurality of second network nodes is less than a node level of the first network node; and a sending module 920 configured to send a target task corresponding to the setup request for the AI network function service to the at least two second network nodes.

In some embodiments of the present disclosure, as shown in FIG. 9, the apparatus 900 further includes: a receiving module 930. The receiving module 930 is configured to receive the setup request for the AI network function service sent by an AMF.

In some embodiments of the present disclosure, in a case where the setup request for the AI network function service carries a type of the AI network function service, and the at least two second network nodes are selected from the plurality of second network nodes, the selecting module 910 may be configured to determine a plurality of second network nodes matched with the type of the AI network function service, and receive node state information of the plurality of second network nodes, in which the node state information at least includes a central processing unit (CPU) calculation frequency, energy consumption information, wireless bandwidth information and channel state information; and select the at least two second network nodes from the plurality of second network nodes based on the node state information and a preset deep reinforcement learning algorithm.

In some embodiments of the present disclosure, the receiving module 930 may be configured to receive a preset task type of the AI network function service uploaded by the second network node; the selecting module 910 may be configured to determine the plurality of second network nodes matched with the type of the AI network function service type according to the preset task type.

In some embodiments of the present disclosure, the preset deep reinforcement learning algorithm includes a DDQN algorithm. In a case of selecting the at least two second network nodes from the plurality of second network nodes based on the node state information and the preset deep reinforcement learning algorithm, the selecting module 910 may be configured to, for a purpose of minimizing system delay and energy consumption and maximizing a number of second network nodes participating in a service, define a state space as the node state information of the second network node, define an action space as a combination of the second network nodes selected for the setup request for the AI network function service, and establish a deep reinforcement learning model based on the DDQN algorithm; and determine, according to the node state information, a reward function of each action in an action set by using the deep reinforcement learning model, and determine an optimal selection decision for the second network node corresponding to the AI network function service according to the reward function, in which the action is used for characterizing a selection decision for the second network node corresponding to the AI network function service, and the optimal selection decision includes at least two second network nodes and task allocation weights of the at least two second network nodes.

In some embodiments of the present disclosure, in a case of determining, according to the node state information, the reward function of each action in the action set by using the deep reinforcement learning model, the selecting module 910 may be configured to determine, according to the node state information, the action set by using the deep reinforcement learning model, and repeatedly perform a determination process of the reward function until a current action is determined to be a last action in the action set; in which the determination process of the reward function includes: taking a next action as the current action according to an action selection order in the action set; receiving a local model parameter uploaded by the second network node included in the current action, and weighted aggregating the local model parameter according to a size of local data to obtain a global model parameter based on a federated average (FedAvg) algorithm; transmitting the global model parameter to a second network node included in the current action to continue to train a task model of the second network node based on the global model parameter, and obtaining a reward function of the current action after training is completed.

In some embodiments of the present disclosure, in a case of determining an optimal selection decision for the target task regarding the second network node based on the reward function, the selecting module 910 may be configured to determine, in the action set, a target action corresponding to a maximum reward function, and determine a selection policy characterized by the target action as an optimal selection decision for the target task regarding the second network node.

In some embodiments of the present disclosure, the sending module 920 may be configured to divide the target task into at least two subtasks according to the task allocation weights of the at least two second network nodes; and send a subtask to a corresponding second network node.

In some embodiments of the present disclosure, as shown in FIG. 9, the apparatus 900 further includes: an aggregating module 940. The aggregating module 940 is configured to receive and aggregate task execution results sent by the at least two second network nodes.

In some embodiments of the present disclosure, the sending module 920 may be configured to send an aggregated task execution result to the AMF.

In some embodiments of the present disclosure, the receiving module 930 may be configured to receive feedback on the aggregated task execution result.

FIG. 10 is a block diagram illustrating an apparatus 1000 for scheduling a task of an artificial intelligence (AI) network function service according to embodiments of the present disclosure. The apparatus 1000 for scheduling the task of the AI network function service may be applied to a second network node.

As shown in FIG. 10, the apparatus 1000 may include: a receiving module 1010 configured to receive a subtask regarding a target task sent by a first network node, in which the subtask is obtained by dividing the target task by the first network node according to a task allocation weight in an optimal selection decision; a performing module 1020 configured to perform the subtask according to a task model completed by local training; and a sending module 1030 configured to send a task execution result to the first network node.

In some embodiments of the present disclosure, the sending module 1030 may further be configured to send node state information and a preset task type of the AI network function service to the first network node, in which the node state information at least includes a central processing unit (CPU) calculation frequency, energy consumption information, wireless bandwidth information and channel state information.

In some embodiments of the present disclosure, as shown in FIG. 10, the apparatus 1000 further includes: a training module 1040. The sending module 1030 may further be configured to send a local model parameter to the first network node. The receiving module 1010 may further be configured to receiving a global model parameter transmitted by the first network node, in which the global model parameter is obtained by the first network node based on a FedAvg algorithm, the first network node weighted aggregates the local model parameter according to a size of local data after receiving the local model parameter uploaded by the second network node included in a current action. The training module 1040 may be configured to obtain the task model completed by the local training by iteratively training the task model based on the global model parameter and using a sample set matched with the target task.

In some embodiments of the present disclosure, the performing module 1020 may be configured to retrieve structured data matched with the subtask in a UDR, and retrieve unstructured data matched with the subtask in a UDSF; and input the structured data and the unstructured data into the task model completed by the local training, and output a task execution result of the subtask by using the task model completed by the local training.

FIG. 11 is a block diagram illustrating an apparatus 1100 for scheduling a task of an artificial intelligence (AI) network function service according to embodiments of the present disclosure. The apparatus 1100 for scheduling the task of the AI network function service may be applied to a UE.

As shown in FIG. 11, the apparatus 1100 may include: a sending module 1110 configured to send a setup request for the AI network function service to an AMF; and a receiving module 1120 configured to receive an aggregated task execution result transparently transmitted by the AMF.

In some embodiments of the present disclosure, as shown in FIG. 11, the apparatus 1100 further includes: a storing module 1130. The storing module 1130 may be configured to store a structured data set of a target task corresponding to the setup request for the AI network function service into a UDR, and store an unstructured data set of the target task corresponding to the setup request for the AI network function service into a UDSF.

In some embodiments of the present disclosure, the sending module 1110 may further be configured to send a receipt response message of a task execution result and feedback on the aggregated task execution result to the AMF.

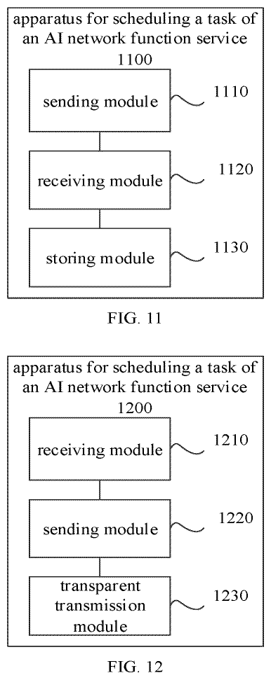

FIG. 12 is a block diagram illustrating an apparatus 1200 for scheduling a task of an artificial intelligence (AI) network function service according to embodiments of the present disclosure. The apparatus 1200 for scheduling the task of the AI network function service may be applied to an AMF.

As shown in FIG. 12, the apparatus 1200 may include: a receiving module 1210 configured to receive a setup request for the AI network function service sent by a UE; and a sending module 1220 configured to send the setup request for the AI network function service to a first network node.

In some embodiments of the present disclosure, as shown in FIG. 12, the apparatus 1200 further includes: a transparent transmission module 1230. The receiving module 1210 may further be configured to receive an aggregated task execution result sent by the first network node; and the transparent transmission module 1230 may be configured to transparently transmit the aggregated task execution result to the UE.

In some embodiments of the present disclosure, the receiving module 1210 may further be configured to receive a receipt response message of a task execution result and feedback on the aggregated task execution result; and the sending module 1220 may further be configured to send the feedback on the aggregated task execution result to the first network node.

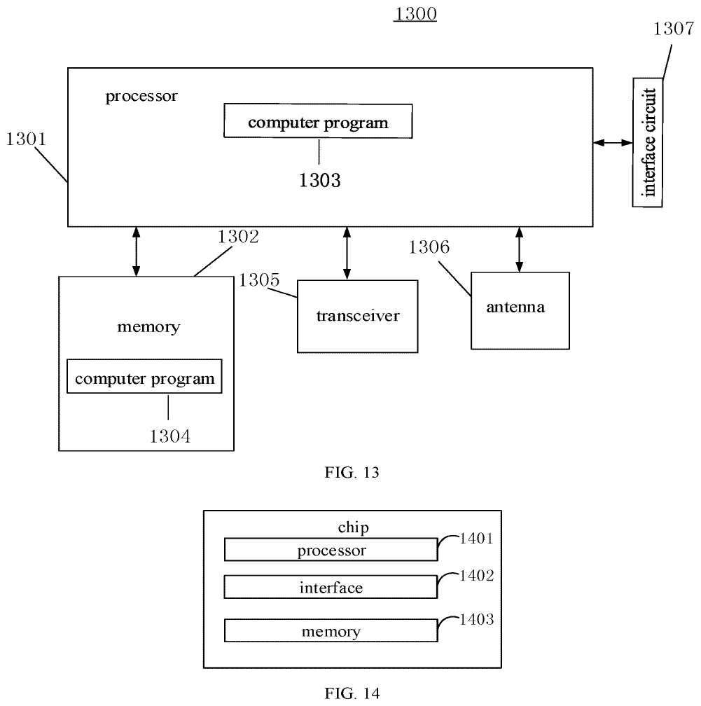

Referring to FIG. 13, FIG. 13 is a structural diagram illustrating a communication device 1300 according to embodiments of the present disclosure. The communication device 1300 may be a network device; a user equipment; a chip, a chip system or a processor supporting the network device to implement the above-mentioned method; and a chip, a chip system or a processor supporting the user equipment to implement the above-mentioned method. The communication device may be configured to implement the method as described in method embodiments described above, with particular reference to the description of method embodiments described above.

The communication device 1300 may include one or more processors 1301. The processor 1301 may be a general-purpose processor or a special-purpose processor, etc. It may be, for example, a baseband processor or a central processor. The baseband processor may be configured to process a communication protocol and communication data, and the central processor may be configured to control a communication device (such as a first node, a second node, a baseband chip, a terminal device, a terminal device chip, a DU or a CU, etc.), execute a computer program and process data of the computer program.

Optionally, the communication device 1300 may further include one or more memories 1302 on which the computer program 1304 may be stored. The processor 1301 executes the computer program 1304 to cause the communication device 1300 to perform the method as described in above method embodiments. Optionally, the memory 1302 may also have the data stored therein. The communication device 1300 and the memory 1302 may be provided independently or integrated together.

Optionally, the communication device 1300 may further include a transceiver 1305 and an antenna 1306. The transceiver 1305 may be referred to as a transceiving unit, a transceiving machine, or a transceiving circuit or the like for implementing a transceiving function. The transceiver 1305 may include a receiver and a transmitter, and the receiver may be referred to as a receiving machine or a receiving circuit or the like for implementing a receiving function; the transmitter may be referred to as a transmitting machine or a transmission circuit or the like for implementing a transmitting function.

Optionally, the communication device 1300 may further include one or more interface circuits 1307. The interface circuit 1307 is configured to receive and transmit the code instructions to the processor 1301. The processor 1301 executes the code instructions to cause the communication device 1300 to perform the method described in above method embodiments.

In an implementation, the processor 1301 may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface or the interface circuit may be configured to read and write code/data, or may be configured to transmit or transfer signals.

In an implementation, the processor 1301 may store the computer program 1303 that, when running on the processor 1301, enables the communication device 1300 to perform the method described in the above-mentioned method embodiments. The computer program 1303 may be embedded in the processor 1301, in which case the processor 1301 may be implemented by hardware.

In an implementation, the communication device 1300 may include a circuit that may perform the transmitting, receiving or communicating function in the foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies, such as complementary metal oxide semiconductors (CMOSs), n-metal-oxide-semiconductors (NMOSs), positive channel metal oxide semiconductors (PMOSs), bipolar junction transistors (BJTs), bipolar CMOSs (BiCMOSs), silicon germanium (SiGe), gallium arsenide (GaAs), etc.

The communication device described in the above embodiments may be a network device or a user equipment, but the scope of the communication device described in the present disclosure is not limited thereto. The structure of the communication device may not be limited by FIG. 13. The communication device may be a stand-alone device or may be part of a larger device. For example, the communication device may be: (1) a stand-alone integrated circuit (IC), or a chip, or a chip system or subsystem; (2) a set of one or more ICs, in which optionally, the set of ICs may also include a storage component for storing data and computer programs; (3) an ASIC, such as a modem; (4) a module that may be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc.; (6) others.

In the case where the communication device may be a chip or a chip system, reference is made to the structural diagram of the chip shown in FIG. 14. The chip shown in FIG. 14 includes a processor 1401 and an interface 1402. The number of processors 1401 may be one or more, and the number of interfaces 1402 may be more than one.

Optionally, the chip further includes a memory 1403 for storing necessary computer programs and data.

Those skilled in the art may also understand that various illustrative logical blocks and steps listed in embodiments of the present disclosure may be implemented by an electronic hardware, a computer software, or a combination thereof. Whether such functions are implemented by a hardware or a software depends on specific applications and design requirements of an overall system. For each specific application, those skilled in the art may use various methods to implement the function, but such an implementation should not be understood as extending beyond the protection scope of embodiments of the present disclosure.

The present disclosure further provides a readable storage medium having stored therein instructions that, when executed by a computer, cause functions of any one of the above method embodiments to be implemented.

The present disclosure further provides a computer program product that, when executed by a computer, causes functions of any one of the above method embodiments to be implemented.

All or some of the above embodiments may be implemented by a software, a hardware, a firmware or any combination thereof. When implemented using the software, all or some of the above embodiments may be implemented in a form of the computer program product. The computer program product includes one or more computer programs. When the computer program is loaded and executed on the computer, all or some of the processes or functions according to embodiments of the present disclosure will be generated. The computer may be a general-purpose computer, a special-purpose computer, a computer network, or other programmable devices. The computer program may be stored in a computer-readable storage medium, or transmitted from one computer-readable storage medium to another computer-readable storage medium. For example, the computer program may be transmitted from one website site, computer, server or data center to another website site, computer, server or data center in a wired manner (such as via a coaxial cable, an optical fiber, a digital subscriber line (DSL)) or a wireless manner (for example, in an infrared, wireless, or microwave manner, or the like). The computer-readable storage medium may be any available medium that can be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

Those of ordinary skill in the art can understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the terms “first”, “second”, “third”, “A”, “B”, “C” and “D” have no order of precedence or size.

As used herein, the terms “machine readable medium” and “computer readable medium” refer to any computer program product, device, and/or apparatus (e.g., a magnetic disk, an optical disk, a memory, a programmable logic device (PLD)) for providing machine instructions and/or data to a programmable processor, including a machine readable medium that receives machine instructions as a machine readable signal. The term “machine readable signal” refers to any signal used to provide the machine instructions and/or data to the programmable processor.

The systems and technologies described herein may be implemented in a computing system (e.g., as a data server) including a background component, a computing system (e.g., an application server) including a middleware component, a computing system including a front-end component (e.g., a user computer having a graphical user interface or a web browser, through which the user may interact with embodiments of the systems and technologies described herein), or a computing system including any combination of such background component, middleware component, or front-end component). Components of the system may be connected to each other by digital data communication (such as a communication network) in any form or medium. Examples of the communication network include a local area network (LAN), a wide area network (WAN), and the Internet.

The computer system may include a client and a server. The client and the server are generally remote from each other and typically interact through the communication network. A client-server relationship is generated by computer programs operating on corresponding computers and having the client-server relationship with each other.

It should be understood that steps may be reordered, added or deleted using various forms of processes illustrated above. For example, each step described in the present disclosure may be executed in parallel, sequentially or in different orders, so long as a desired result of the technical solution disclosed in the present disclosure may be achieved, which is not limited here.

Furthermore, it should be understood that various embodiments of the present disclosure may be implemented alone or in combination with other embodiments, as the solution allows.

Those skilled in the art may appreciate that units and algorithm steps of each example described in conjunction with embodiments disclosed herein may be implemented with the electronic hardware, or combinations of the computer software and the electronic hardware. Whether such functionality is implemented in hardware or software depends on the specific application and design constraints of the technical solution. Those skilled in the art may implement the described functionality in varying ways for each particular application, but such implementation should not be considered to be beyond the scope of the present disclosure.

It will be clear to those skilled in the art that, for convenience and brevity of the description, specific working procedures of the above described systems, devices and units may refer to corresponding procedures in the preceding method embodiments and will not be described in detail here.

The above description is only for the specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present disclosure shall be in line with the attached claims.

1. A method for scheduling a task of an artificial intelligence (AI) network function service, performed by a first network node, comprising:
selecting at least two second network nodes from a plurality of second network nodes in response to a setup request for the AI network function service, wherein a node level of the plurality of second network nodes is less than a node level of the first network node; and
sending a target task corresponding to the setup request for the AI network function service to the at least two second network nodes.

2. The method of claim 1, further comprising:
receiving the setup request for the AI network function service sent by an access and mobility management function (AMF).

3. The method of claim 1, wherein the setup request for the AI network function service carries a type of the AI network function service, and selecting the at least two second network nodes from the plurality of second network nodes comprises:
determining a plurality of second network nodes matched with the type of the AI network function service, and receiving node state information of the plurality of second network nodes, wherein the node state information at least comprises a central processing unit (CPU) calculation frequency, energy consumption information, wireless bandwidth information and channel state information; and
selecting the at least two second network nodes from the plurality of second network nodes based on the node state information and a preset deep reinforcement learning algorithm.

4. The method of claim 3, further comprising:
receiving a preset task type of the AI network function service uploaded by the second network node;
wherein determining the plurality of second network nodes matched with the type of the AI network function service comprises:
determining the plurality of second network nodes matched with the type of the AI network function service according to the preset task type.

5. The method of claim 3, wherein the preset deep reinforcement learning algorithm comprises a double deep Q-network (DDQN) algorithm, and selecting the at least two second network nodes from the plurality of second network nodes based on the node state information and the preset deep reinforcement learning algorithm comprises:
for a purpose of minimizing system delay and energy consumption and maximizing a number of second network nodes participating in a service, defining a state space as the node state information of the second network node, defining an action space as a combination of the second network nodes selected for the setup request for the AI network function service, and establishing a deep reinforcement learning model based on the DDQN algorithm; and
determining, according to the node state information, a reward function of each action in an action set by using the deep reinforcement learning model, and determining an optimal selection decision for the second network node corresponding to the AI network function service according to the reward function, wherein the action is used for characterizing a selection decision for the second network node corresponding to the AI network function service, and the optimal selection decision comprises at least two second network nodes and task allocation weights of the at least two second network nodes.

6. The method of claim 5, wherein determining, according to the node state information, the reward function of each action in the action set by using the deep reinforcement learning model comprises:
determining, according to the node state information, the action set by using the deep reinforcement learning model, and repeatedly performing a determination process of the reward function until a current action is determined to be a last action in the action set;
wherein the determination process of the reward function comprises: taking a next action as the current action according to an action selection order in the action set; receiving a local model parameter uploaded by the second network node comprised in the current action, and weighted aggregating the local model parameter according to a size of local data to obtain a global model parameter based on a federated average (FedAvg) algorithm; transmitting the global model parameter to the second network node comprised in the current action to continue to train a task model of the second network node based on the global model parameter, and obtaining a reward function of the current action after training is completed.

7. The method of claim 5, wherein determining an optimal selection decision for the target task regarding the second network node based on the reward function comprises:
determining, in the action set, a target action corresponding to a maximum reward function, and determining a selection policy characterized by the target action as an optimal selection decision for the target task regarding the second network node.

8. The method of claim 5, wherein sending the target task corresponding to the setup request for the AI network function service to the at least two second network nodes comprises:
dividing the target task into at least two subtasks according to the task allocation weights of the at least two second network nodes; and
sending a subtask to a corresponding second network node.

9. The method of claim 1, further comprising at least one of:
receiving and aggregating task execution results sent by the at least two second network nodes, and sending an aggregated task execution result to an AMF; or
receiving feedback on the aggregated task execution result.

10.-11. (canceled)

12. A method for scheduling a task of an artificial intelligence (AI) network function service, performed by a second network node, comprising:
receiving a subtask regarding a target task sent by a first network node, wherein the subtask is obtained by dividing the target task by the first network node according to a task allocation weight in an optimal selection decision;
performing the subtask according to a task model completed by local training; and
sending a task execution result to the first network node.

13. The method of claim 12, further comprising:
sending node state information and a preset task type of the AI network function service to the first network node, wherein the node state information at least comprises a central processing unit (CPU) calculation frequency, energy consumption information, wireless bandwidth information and channel state information.

14. The method of claim 12, wherein before performing the subtask according to the task model completed by the local training, the method further comprises:
sending a local model parameter to the first network node;
receiving a global model parameter transmitted by the first network node, wherein the global model parameter is obtained by the first network node based on a federated average (FedAvg) algorithm, the first network node weighted aggregates the local model parameter according to a size of local data after receiving the local model parameter uploaded by the second network node comprised in a current action; and
obtaining the task model completed by the local training by iteratively training the task model based on the global model parameter and using a sample set matched with the target task.

15. The method of claim 12, wherein performing the subtask according to the task model completed by the local training comprises:
retrieving structured data matched with the subtask in a user data register (UDR), and retrieving unstructured data matched with the subtask in an unstructured data storage function (UDSF); and
inputting the structured data and the unstructured data into the task model completed by the local training, and outputting a task execution result of the subtask by using the task model completed by the local training.

16. A method for scheduling a task of an artificial intelligence (AI) network function service, comprising:
sending, by a user equipment (UE), a setup request for the AI network function service to an access and mobility management function (AMF); and
receiving, by the UE, an aggregated task execution result transparently transmitted by the AMF.

17. The method of claim 16, further comprising at least one of:
storing, by the UE, a structured data set of a target task corresponding to the setup request for the AI network function service into a user data register (UDR), and storing, by the UE, an unstructured data set of the target task corresponding to the setup request for the AI network function service into an unstructured data storage function (UDSF); or
sending, by the UE, a receipt response message of a task execution result and feedback on the aggregated task execution result to the AMF.

18. (canceled)

19. The method of claim 16, comprising:
receiving, by the AME, a setup request for the AI network function service sent by the UE; and
sending, by the AME, the setup request for the AI network function service to the first network node.

20. The method of claim 19, further comprising:
receiving an aggregated task execution result sent by the first network node; and
transparently transmitting the aggregated task execution result to the UE.

21. The method of claim 20, further comprising:
receiving a receipt response message of a task execution result and feedback on the aggregated task execution result; and
sending the feedback on the aggregated task execution result to the first network node.

22.-25. (canceled)

26. A communication device, comprising:
a transceiver;
a memory; and
a processor, respectively connected to the transceiver and the memory, configured to control receiving and sending a wireless signal of the transceiver by executing computer-executable instructions on the memory, and perform the method of claim 1.

27.-29. (canceled)

30. A communication device, comprising:
a transceiver;
a memory; and
a processor, respectively connected to the transceiver and the memory, configured to control receiving and sending a wireless signal of the transceiver by executing computer-executable instructions on the memory, and perform the method of claim 12.
